(19) United States
(12) Patent Application Publication
(10) Pub. No.: US 2016/0231198 A1
(43) Pub. Date: Aug. 11, 2016

(54) Clutch Sensor System

(71) Applicant: ROBERT BOSCH GMBH, Stuttgart (DE)

(72) Inventors: Udo Kaess, Walheim (DE); Thorsten Droigk, Ludwigsburg (DE); Peter Weiberle, Sachsenheim (DE); Olivier Kukawka, Ludwigsburg (DE)

(21) Appl. No.: 15/029,754

(22) PCT Filed: Aug. 26, 2014
(86) PCT No.: PCT/EP2014/068033

§ 371 Date: Apr. 15, 2016

(30) Foreign Application Priority Data
Oct. 17, 2013 (DE) 102013221056.6

(51) Int. Cl. G01M 13/02; G01D 5/14; G01S 13/88; G01D 5/16; G01D 5/20; F16D 11/14; G01D 5/26

(52) U.S. Cl. CPC G01M 13/022; F16D 11/14; G01D 5/142; G01D 5/26; G01D 5/16; G01D 5/20; G01S 13/88; F16D 2300/18

(57) ABSTRACT

A clutch sensor system includes a clutch part that is rotatable about and axially displaceable along an axis of rotation, and a sensor device having at least one sensor element configured to detect a rotary movement parameter of the clutch part. A circumferential transmitter structure is disposed on a circumference of the clutch part, and has a first sub-structure and at least one second sub-structure that follow each other in alternating fashion in a circumferential direction. The sub-structures are separated by structure transitions that move past a detection area of the sensor element as the clutch part rotates, whereby the sensor device generates a sensor signal that includes information about the rotary movement parameter. A circumferential distance between successive structure transitions depends on an axial displacement of the clutch part, such that the sensor signal also includes information about the axial displacement position of the clutch part.

### PRIOR ART

The invention relates to a clutch sensor system comprising a clutch part, which can rotate about a rotation axis and can be axially displaced in the direction of the rotation axis, and a sensor device. Clutch sensor systems of this kind are used, for example, in automatic transmissions of motor vehicles in order to monitor the clutch state, for example of a claw clutch, of the transmission. The known systems use two different sensor devices, wherein a first sensor device detects the rotational movement of a rotatable clutch part. Said first sensor device may be, for example, a customary rotation speed sensor, for example a differential Hall sensor. To this end, a rotatable clutch part is provided, on its circumference, for example, with a circumferential gearwheel structure which has teeth and tooth gaps which follow one another in an alternating manner in the rotation direction and which are separated by transitions. In the event of rotation of the rotatable clutch part, the respective transitions from tooth to tooth gap are routed past a detection region of the sensor element of the sensor device. The sensor element forms a rotation speed signal, which represents the rotational movement variable, depending on the detection of the transitions. In known solutions, the axial displacement position of the clutch part is detected by means of a separate sensor device, for example a travel sensor. The known systems require different transmitter structures and sensor devices. In addition, a relatively large amount of installation space is required for arrangement on the clutch since the rotation speed signal and the travel signal, which represents the axial displacement position, are detected at separate locations.

### DISCLOSURE OF THE INVENTION

### Advantages of the Invention

The clutch sensor system according to the invention having the features of claim 1 has the advantage that a rotational movement variable, such as the rotation speed, and the axial displacement position of a clutch part can be detected in a simplified manner. To this end, the clutch sensor system has a special transmitter structure having at least two substructures which are designed such that the circumferential distance between a structure transition which is detected by the sensor device in the event of a rotational movement of the rotatable clutch part and a structure transition which directly or indirectly follows in the rotation direction of the rotatable clutch part and is detected by the sensor device is dependent on the axial displacement of the rotatable clutch part, so that the sensor device generates a sensor signal which, in addition to the information about the rotational movement variable of the rotatable clutch part, contains information about the axial displacement position of the clutch part. Advantageously, the cabling complexity and the installation space can be reduced, wherein the clutch sensor system reliably detects the rotational movement variable and the axial displacement position of the rotatable clutch part and therefore enables precise clutch actuation.

Advantageous refinements and developments of the invention are made possible by the features which are cited in the dependent claims.

In principle, the transmitter structure can have an extremely wide variety of designs. However, it is particularly advantageous when the transmitter structure is designed with structural elements of substructures which follow one another in an alternating manner such that at least one structure transition has an inclined section which is inclined in relation to the rotation axis of the rotatable clutch part, and a structure transition which directly or indirectly follows in the rotation direction has a section which does not run parallel in relation to the inclined section. This has the effect, in a simple manner, that the circumferential distance, which is scanned by the sensor device, of at least these two structure transitions is dependent on the axial displacement position of the clutch part. In this case, embodiments are possible in which the transmitter structure has only one inclined section on only one single structure element, or has an inclined section on a plurality of, but not all, structure elements, or else has a respective inclined section on all structure elements.

The first substructure and/or the second substructure can consist of, for example, a series of structure elements of identical design. For instance, the transmitter structure can have, for example, an arrangement of serrated structure elements which follow one another in an alternating manner as seen in the rotation direction. However, it is also possible for the first substructure and/or the second substructure to be formed from a series of structure elements of different design which are arranged in an alternating manner in the rotation direction.

In one exemplary embodiment, the sensor device can have only a single sensor element. However, it is also possible for the sensor device to have two or more sensor elements which are arranged at a distance from one another in the direction of the rotation axis and which are physically separate from one another or else are combined to form a physical unit.

The sensor device has, for example, at least one or two sensor elements of the following sensor types: differential Hall sensor, Hall sensor or Hall IC, inductive sensor element, AMR sensor (Anisotropic Magneto-Resistive sensor), GMR sensor (Giant Magneto-Resistive sensor), optical sensor, ultrasound sensor or radar sensor, wherein this list is not exhaustive.

The sensor device advantageously generates a sensor signal which comprises a series of signal pulses depending on the detection of the structure transitions which are routed past. The sensor signal can be a signal which is detected by the sensor device, or a signal which is further processed by the sensor device and is provided at the output.

In an advantageous exemplary embodiment, the sensor signal contains, for example, a sequence of at least three successive signal pulses comprising a first signal pulse, a second signal pulse and a third signal pulse, wherein the ratio of the time interval between the first signal pulse and the second signal pulse and of the time interval between the second signal pulse and the third signal pulse contains information about the axial displacement position of the rotatable clutch part.

In another advantageous exemplary embodiment however, it can also be provided, for example, that the ratio of the pulse duration of a signal pulse of the sensor signal to the period duration of the sensor signal contains information about the axial displacement position of the rotatable clutch part or represents the axial displacement position.

A value which represents the rotational movement variable can advantageously be detected depending on the number of signal pulses detected in a prespecifiable time interval or depending on the time interval between the signal pulses.

In an advantageous embodiment, the structure elements which follow one another in an alternating manner in the rotation direction are formed by a geometric design of the circumference of the rotatable clutch part in the manner of a gearwheel geometry, wherein the first substructure has teeth as structure elements and the second substructure has tooth gaps, which are situated between two teeth in each case, as structure elements. The tooth gaps can be produced in a particularly simple manner by milling, as a result of which the inclined sections which have already been described further above can also be produced in a simple manner. A magnetic field-sensitive sensor element can advantageously be related in combination with the gearwheel geometry, wherein a magnetic field is generated, for example, in the sensor detection region of the at least one sensor element, and the sensor device detects a change in magnetic field when teeth and tooth gaps are routed past the sensor detection region of the at least one sensor element of the sensor device. In this case, the sensor element can advantageously be in the form of a differential Hall sensor for example.

In a further exemplary embodiment, it is provided that the structure elements which follow one another in an alternating manner in the rotation direction are formed by a magnetic pole structure on the circumference of the rotatable clutch part (pole wheel), wherein the structure transitions are formed between the first and the second substructure by magnetic north/south transitions. In this case, the sensor device detects a change in magnetic field when a magnetic north/south transition is routed past the sensor detection region of the at least one sensor element. Magnetically active transmitter structures in the form of pole wheels can be produced without problems.

A further embodiment provides that the structure elements which follow one another in an alternating manner in the rotation direction are realized by a design of the optical surface condition of the circumference of the rotatable part, wherein the first substructure and the second substructure have an optically different surface. In this case, the sensor device is, for example, an optical sensor element which, in the sensor detection region, can detect electromagnetic radiation, in particular light, which is reflected from the surface. Advantageously, geometric design of the circumference of the clutch part is not required for this purpose, but rather only suitable surface processing, for example by roughening or sand-blasting the surface or applying color, it being possible to carry out said surface processing without a great deal of expenditure.

The clutch sensor system can preferably be part of a motor vehicle transmission clutch or part of a separating clutch of a motor vehicle, which separating clutch connects the drive side to the output side, without being restricted to these applications.

In the context of the present application, a clutch is an apparatus for transmitting a torque with which at least one rotatable and axially displaceable clutch element is bought into engagement and therefore into operative connection with a second clutch element in a releasable manner. The clutch can be, for example, a claw clutch of a vehicle transmission. However, said clutch can also be another clutch, for example a diaphragm spring clutch or the like.

A rotatable clutch part is understood to mean any part of a multipartite clutch which is either coupled in a rotationally fixed manner to at least one rotating and axially displaceable clutch element of the clutch, which clutch element is required for engaging the clutch, or is first coupled to said clutch element during the coupling process or else constitutes said clutch element itself.

A circumference of the clutch part is understood to mean the circumferential side of the clutch part in the vertical viewing direction with respect to the rotation axis. Said circumference can be, for example, a geometry which is in the form of a cylinder casing. Forming the transmitter structure on the circumference of the clutch part is critical to the invention. The design of the circumference of the clutch part outside of the transmitter structure is not important.

The rotation direction is understood to mean the direction of rotation with or else against the rotation of the clutch part.

Within the context of the application, a circumferential distance is understood to mean the physical distance between two points on an imaginary rolling-over curve of the transmitter structure of the rotatable part in flat form.

A sensor detection region is understood to mean a flat or physically expanded, two- or three-dimensional region between that region of the circumference of the clutch part which faces the sensor element and the sensor element. The sensor element detects structure transitions and therefore changes in structure of the transmitter structure when said structure transitions pass the sensor detection region.

In the context of the present application, the transmitter structure can preferably be represented by a physical or geometric design of the circumference of the rotatable part or by magnetic poles which are distributed over the circumference or by an optical design of the surface at the circumference of the rotatable part, without being restricted thereto.

A structure transition is understood to mean the transition between in each case two adjacent structure elements as seen in the rotation direction. The structure transition can be in the form of a line, an edge, a magnetic pole transition or the like. Said transition can also be a region which is somewhat extended in the rotation direction, for example a continuous transition region.

A structure transition which directly follows a structure transition under consideration in the rotation direction is understood to mean the next structure transition detected by the sensor device as seen in the rotation direction.

A structure transition which indirectly follows a structure transition under consideration in the rotation direction is understood to mean a structure transition which is not the structure transition detected next and which can be separated from the first detected structure transition by further structure transitions as seen in the rotation direction.

The first and the second substructure of the transmitter structure are understood to mean two substructures of the transmitter structure, wherein the transmitter structure does not have to be restricted to subdivisions into two substructures and can additionally also have a third, fourth or more substructures for example.

Information about the axial displacement position of the clutch part is understood to mean information which enables the relative or absolute axial displacement position of the clutch part to be calculated in a reliable manner in the event of a displacement in the direction of the rotation axis which occurs during operation.

### BRIEF DESCRIPTION OF THE DRAWINGS

Exemplary embodiments of the invention are illustrated in the drawing and will be explained in greater detail in the following description. In the drawing

FIG. 1 shows a basic construction of the clutch sensor system,

FIG. 2 is a schematic illustration of a plan view of an exemplary embodiment of the transmitter structure looking from the sensor element to the transmitter structure,

FIG. 3a shows an example of the signal which is generated by the sensor element when the sensor detection region crosses the track S1 in FIG. 2 in the event of a rotational movement of the rotatable part,

FIG. 3b shows an example of the signal which is generated by the sensor element when the sensor detection region crosses the track S2 in FIG. 2 in the event of a rotational movement of the rotatable part,

FIGS. 4 and 5 show alternative exemplary embodiments of the transmitter structure,

FIG. 6 shows a cross section through an exemplary embodiment of the transmitter structure from FIG. 2 for the special case of a physically or geometrically structured transmitter structure,

FIG. 7 is an illustration of the transmitter structure and the corresponding sensor signal for a further exemplary embodiment of the invention, and

FIGS. 8 and 9 show further exemplary embodiments of the transmitter structure according to the invention.

### EMBODIMENTS OF THE INVENTION

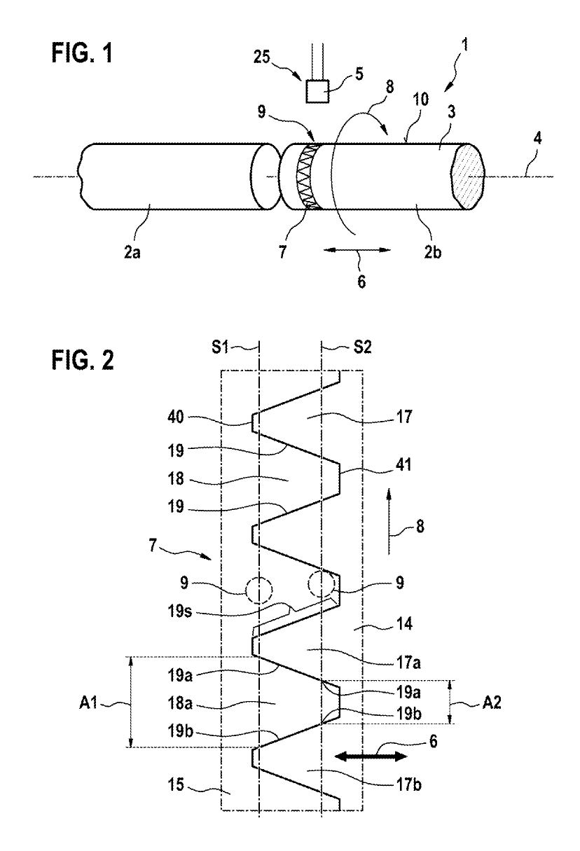

FIG. 1 shows the basic and highly simplified construction of a clutch sensor system 1. The clutch sensor system 1 comprises a clutch having at least two clutch elements 2a and 2b, it being possible for a torque to be transmitted between said clutch elements by establishing a clutch connection. To this end, the clutch elements 2 and 3 can be brought into engagement with one another, wherein the engagement can be established with a friction fit, a form fit, a force fit or in some other way. By virtue of closing the clutch, a torque can be transmitted from the clutch element 2a, which is coupled to the clutch input end for example, to the clutch element 2b, which is coupled to the clutch output end for example, or vice versa. The first and the second clutch element can be designed such that they can rotate in or against the illustrated rotation direction 8, wherein at least one of the clutch elements, for example the clutch element 2b, can be displaced in the axial direction 6. The clutch may be, for example, a claw clutch of a motor vehicle transmission.

The clutch element 2b is mechanically connected to a clutch part 3. Therefore, the clutch part 3, like the clutch element 2b, is arranged such that it can rotate on the rotation axis 4 and is arranged such that it can be displaced in the direction of the rotation axis 4. In FIG. 1, the clutch part 3 forms the second clutch element 2b. However, it is also possible for the clutch part 3 to be formed by a separate part which is connected to the clutch element 2b only subsequently. It is important that the rotational movement of the clutch part 3 in the rotation direction 8 and the axial displacement 6 of the clutch part 3 are coupled to those of the clutch element 2b in order to be able to detect the clutch state of the clutch sensor system 1 by means of a sensor device 25.

To this end, the clutch part 3 is provided, on its circumference 10 which is illustrated simply as a cylinder casing surface in FIG. 1, with a transmitter structure 7 which runs as seen in the rotation direction 8. The transmitter structure 7 is merely indicated in FIG. 1. The sensor device 25 has, for example, a sensor element 5 which is located at a radial distance from the circumference 10 of the transmitter structure 7 and preferably looks directly vertically at the transmitter structure 7. The region of the transmitter structure 7 which is spanned by the sensor element, that is the region between the transmitter structure 7 and the sensor element 5, forms a sensor detection region 9. The sensor detection region 9 can be considerably smaller than the transmitter structure 7.

FIG. 2 shows an example of the transmitter structure 7. In this case, FIG. 2 schematically shows a portion of a rolling-over curve of the circumferential transmitter structure 7 from FIG. 1 in flat form. Therefore, the rotation direction 8 is located in the plane of the illustration of FIG. 2 and has been indicated accordingly. The arrow 6 marks the axial displacement of the transmitter structure 7 in relation to the sensor device 25 or the sensor detection region 9. Here, the transmitter structure 7 is formed, for example, by serrated structure elements which follow one another in an alternating manner as seen in the rotation direction 8 and the tips of which point alternately to the right and to the left in FIG. 2.

As is clearly shown in FIG. 2, the transmitter structure 7 comprises a first substructure 14 and a second substructure 15. The exemplary embodiments illustrated here contain embodiments with two substructures of the transmitter structure 7. It goes without saying that exemplary embodiments which are formed from three, four or more substructures are also possible.

The first and the second substructure 14, 15 have periodically arranged structure elements 17, 18 which are of, for example, serrated form in FIG. 2. The structure elements of the first substructure 14 have been provided with reference symbol 17, and the structure elements of the second substructure 15 have been provided with reference symbol 18. It is clear that the structure elements 17 of the first substructure 14 are all of identical design in this exemplary embodiment. Similarly, the structure elements 18 of the second substructure 15 are all of identical design for example. The structure elements of the first substructure 14 and the structure elements 18 of the second substructure 15 follow one another in an alternating manner as seen in the rotation direction 8, so that the first substructure 14 and the second substructure 15 behave, for example, like two interengaging combs.

A respective structure transition 19 is located between the structure elements 17 of the first substructure 14 and the structure elements 18 of the second substructure 15. The structure transition can be in the form of a line, an edge, a magnetic pole transition or the like. Said structure transition can also be a region which is somewhat extended in the rotation direction 8, for example a continuous transition region. It is important that the the sensor device 25 or the sensor element 9 detects when a structure transition 19 passes the sensor detection region 9. The manner in which this can be achieved will be explained more precisely further below. Each structure element in FIG. 2 has two structure transitions to adjacent structure elements. By way of example, a first structure element of the second substructure 15, which first structure element is designated 18a in FIG. 2, has a structure transition 19a to a first structure element 17a of the first substructure 14 and a structure transition 19b to a second structural element 17b of the first substructure 14.

The sensor element 5 scans the transmitter structure along a path or track which depends on the axial displacement 6 of the clutch part 3. The tracks S1, S2 are illustrated using dashed lines in FIG. 2. In a first displacement position, the sensor element 5 scans, for example, the transmitter structure 7 along the track S1. If the clutch part 3 is then displaced to the left in FIG. 2 along the axial displacement 6 in FIG. 2, the sensor element 5 now scans the transmitter structure 7 along the track S2. In the event of rotation of the clutch part 3 and therefore also of the transmitter structure 7 about the rotation axis 4, the sensor detection region 9 of the sensor element 5 moves over the structure elements 17 and 18 along the track S1 or S2 in the rotation direction 8 and scans the structure transitions 19 of said structure elements.

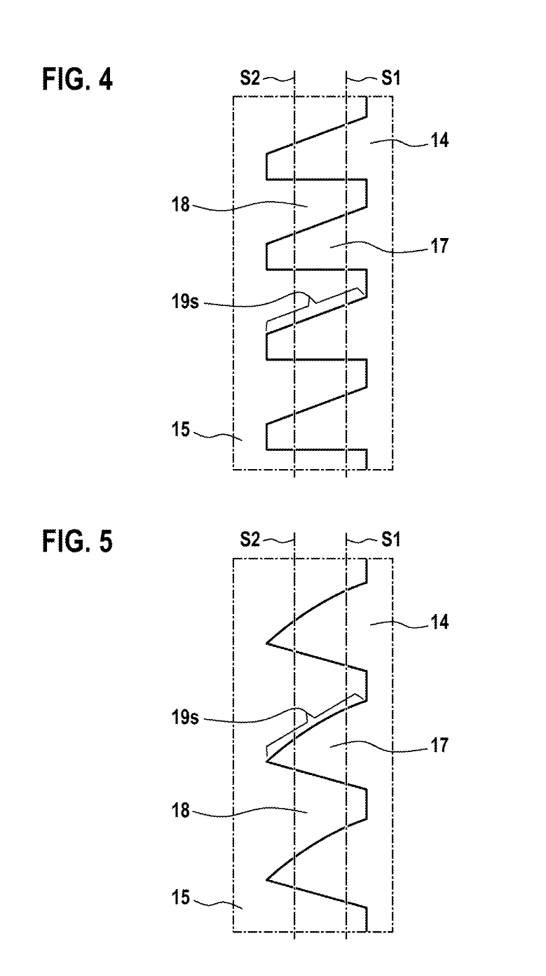

According to the invention, the transmitter structure is designed such that the circumferential distance A1, A2 of a structure transition 19 which is detected by the sensor element 5 in the event of a rotational movement of the rotatable clutch part 3 from a structure transition which is detected directly or indirectly afterward depends on the axial displacement 6 of the clutch part. This can be achieved, for example, by the the structure transitions 19 from one structure element to the next structure element having an inclined section 19s which is inclined in relation to the rotation axis 4 and therefore also in relation to the direction of the axial displacement 6. Each structure element of a substructure in FIG. 2 has two structure transitions to adjacent structure elements of the other substructure. It is possible for each of the two structure transitions to have an inclined section 19s, as is illustrated in FIG. 2. However, it is also possible for only one of the two structure transition to have an inclined section 19s and for the other structure transition to not run parallel in relation to the inclined section 19s. An alternative exemplary embodiment of a transmitter structure 7 is shown in FIG. 4. Each structure element in FIG. 4 has a first structure transition with an inclined section 19s. The second structure transition runs parallel in relation to the rotation axis 4 and is not inclined. A further exemplary embodiment is shown in FIG. 5. In said figure, the structure transition 19 is formed, for example, by a uniformly curved section which, as a result, forms the inclined section 19s relative to the rotation axis 4. The other structure transition of each structure element 17, 18 is, for example, of rectilinear design and inclined at a different angle to the rotation axis 4.

For the situation in which the sensor element 5 scans the track S1 in the event of rotation of the transmitter structure 7 in the illustrated rotation direction 8, it can be seen in FIG. 2 that the sensor detection region 9 moves downward along the track 1.

The first structure element 18a of the second substructure 15, for example, is now looked at. The sensor element 5 initially detects, for example, the structure transition 19a between a first structure element 17a of the first substructure 14 and the first structure element 18a of the second substructure 15. As the next structure transition in the event of rotation in the rotation direction 8, the sensor element 5 detects the structure transition 19b between the first structure element 18a of the second substructure 15 and a second structure element 17b of the first substructure 14. The circumferential distance A1 between the two structure transitions 19a and 19b is dependent on the track S1 for the first structure element 18a under consideration of the second substructure 15, since if the clutch part 3 is displaced to the left with the transmitter structure in FIG. 2, the sensor element 5 now scans the track S2. In this case, the circumferential distance A2 between these two structure transitions 19a and 19b under consideration of this first structure element 18a of the second substructure 15 becomes considerably smaller. The change in the circumferential distance between the structure transitions from A1 to A2 can be attributed to the inclination of the structure transitions 19. The result of this is that the circumferential distance A1 or A2 depends on the axial displacement position of the transmitter structure 7.

As is clear, the dependence exists not only for the first structure element 18a of the second substructure 15 but also likewise for all other structure elements in this exemplary embodiment. The dependence of the circumferential distance on the axial displacement is ensured here, for example, for all of the structure elements of the transmitter structure, wherein the circumferential distance is sometimes increased and sometimes reduced, depending on the structure element under consideration.

It goes without saying that only the inclination of one of the two flanking structure transitions of a structure element is important for the purpose of achieving this dependence. In the exemplary embodiments shown in FIG. 4 or FIG. 5, the circumferential distance between two structure transitions which are detected one after the other is likewise dependent on the axial displacement 6. As already stated, it is not necessary for every structure element to have an inclined section. In borderline cases, a single inclined section on one of the structure elements is sufficient.

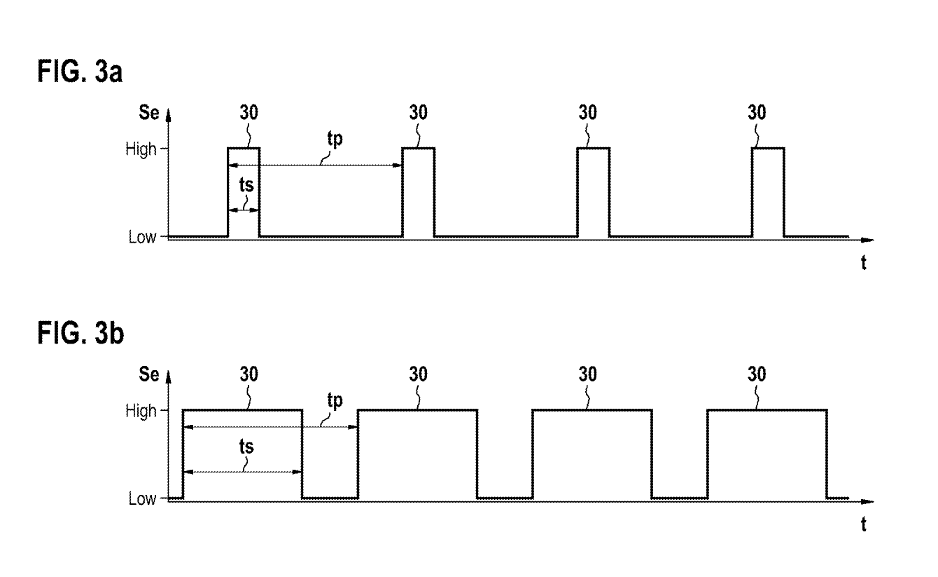

FIG. 3a shows an example of a sensor signal which is generated by the sensor device 25 when the track S1 is scanned. Time is plotted on the horizontal axis and the magnitude of the sensor signal is plotted on the vertical axis, it being possible for the sensor signal to be a voltage signal for example. The sensor device 25 has, for example, a sensor element 5 which is in the form of a differential Hall sensor which is operated as a so-called peak detector. This special differential Hall sensor, which is commercially available from Allegro for example, switches a sensor level from high to low, and vice versa, when a structure transition 19 is detected. Therefore, the sensor element 5 generates, for example, a binary sensor signal Se, wherein the sensor element 5 switches a signal level from low to high when a structure transition 19 is detected and switches the signal level back from high to low when the next structure transition 19 is detected. This produces the sensor signal comprising sensor pulses 30 shown in FIG. 3a.

In the event of an axial displacement of the transmitter structure 7, the signal changes and now generates the sensor signal Se shown in FIG. 3b when the transmitter structure is scanned in track S2. It can be seen in FIG. 3a and FIG. 3b that the duration of a high level 30 defines a pulse duration ts and that the ratio of this pulse duration ts to the period duration tp of the sensor signal Se is dependent on the axial displacement position of the transmitter structure 7 and of the rotatable clutch part 3. It can likewise be seen that the period duration tp is independent of the axial displacement 6 and that a value which represents the rotational movement variable can be detected depending on the number of or the distance between the signal pulses 30 which are detected in a prespecifiable time interval. Therefore, knowing the number of structure elements of the transmitter structure 7 means the rotation speed of the clutch part can be directly calculated in a simple manner, for example. In this way, the sensor element 5 presented here generates a sensor signal Se which represents, in addition to the rotational movement variable of the rotatable clutch part 3, the axial displacement position of the clutch part 3.

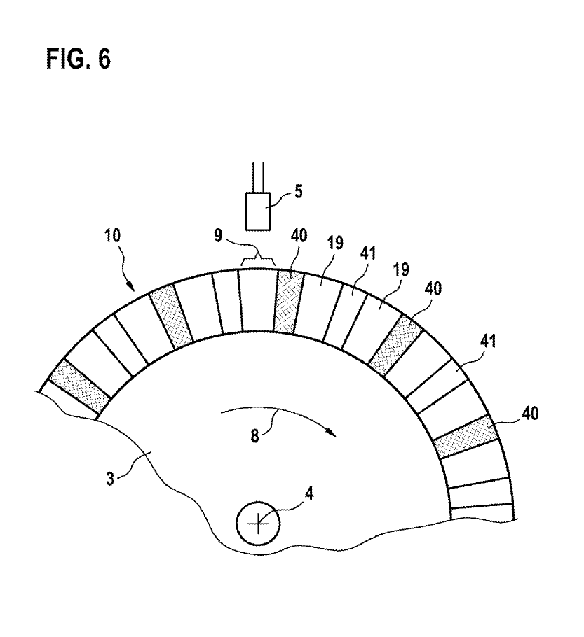

In the context of the present application, signal generation can be based on different physical principles. In an advantageous exemplary embodiment, the transmitter structure is realized by a geometric design of the circumference 10 of the clutch part 3. A cross section through a clutch part 3 of this kind is shown in FIG. 6 for the exemplary embodiment illustrated in FIG. 2. Here, the transmitter structure 7 is formed in the form of a series of teeth as the first substructure 14, said teeth being separated by tooth gaps 41 as the second substructure 15. The flanks of the teeth are inclined in relation to the rotation axis 4, so that the inclined structure transitions 19 illustrated in FIG. 2 are produced between tooth and tooth gap. The sensor element 5 can be designed as a simple Hall sensor element, Hall IC, differential Hall sensor or inductive sensor element. A permanent magnet, not illustrated, for example a back-bias magnet, can generate a magnetic field in the sensor detection region 9. In the event of rotation of the transmitter structure 7, teeth and tooth gaps move through the sensor detection region 9, as a result of which the magnetic field in the sensor detection region is periodically modified. The sensor element 5 detects the change in the magnetic field strength and switches, for example, when a threshold value which is stored in the sensor element is exceeded. As a result, the sensor switches when a structure transition from tooth to tooth gap or from tooth gap to tooth is detected and therefore generates, for example, a binary output signal.

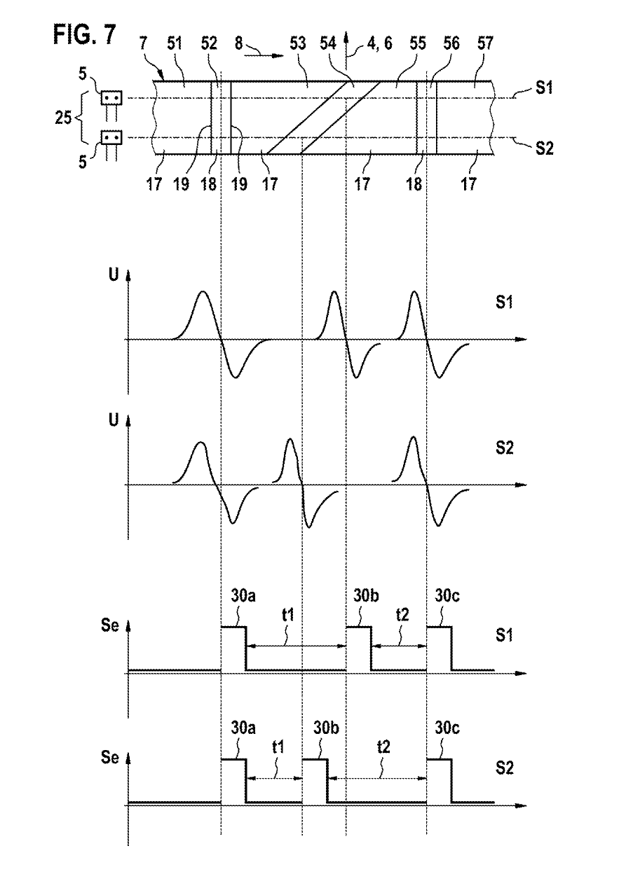

A particularly advantageous exemplary embodiment of the present invention is illustrated in FIG. 7. The transmitter structure 7 of this exemplary embodiment is illustrated in the top part of FIG. 7. The clutch part 3 is, for example, a ferromagnetic transmitter wheel which has tooth gaps 52, 54, 56 made in its circumference 10 by milling, so that the transmitter wheel has teeth 51, 53, 55 and 57 which are located between the tooth gaps 52, 54, 56. The transmitter structure 7 illustrated in the top part of FIG. 7 continues to the left and to the right in a periodically corresponding manner. As can now be seen, the tooth gaps 52, 54, 56, that is the milled slots, form the structure element 18 of the second substructure 15, while the teeth 51, 53, 55 and 57 form the structure elements 17 of the first substructure 14. Therefore, in this exemplary embodiment too, the transmitter structure 7 has structure elements 17, 18 of a first substructure 14 and of a second substructure 15, which structure elements follow one another in an alternating manner in the rotation direction 8. However, in contrast to the exemplary embodiment illustrated in FIG. 2, the structure elements 17 of the first substructure 14 and likewise the structure elements 18 of the second substructure 15 are not all of identical design here. As can be seen in FIG. 7, the tooth gaps 52 and 56 of the second substructure are formed parallel in relation to the axis 4 and therefore also parallel in relation to the axial displacement direction 6, while the tooth gaps 54 have been milled into the circumference of the transmitter wheel in a manner inclined in relation to the axis 4. As a result, the second substructure 15 comprises an alternating sequence of tooth gaps or slots which are oriented parallel and inclined in relation to the axis 4. Analogously to the tooth gaps, the first substructure 14 comprises a series of two teeth 53, 55 of different design in an alternating manner as seen in the rotation direction 8. It can therefore be seen that the teeth 53 and 55 are of mirror-symmetrical design in relation to one another. The tooth 57 again corresponds to the tooth 53, while the tooth 55 corresponds to the tooth 51. It can likewise be clearly seen in the top part of FIG. 7 that, in this exemplary embodiment, the sensor device 25 always has two structure transitions 19 which run parallel in relation to the axis 4, followed by two structure transitions 19 which run in a manner inclined in relation to the axis 4, and then again two structure transitions 19 which run parallel in relation to the axis 4, as seen in the rotation direction 8.

In this exemplary embodiment, the sensor device 25 illustrated in FIG. 7 can comprise, for example, two sensor elements 5 which are spaced apart from one another in the direction of the rotation axis and which each scan the tracks S1 and S2 at the same time. In the event of an axial displacement 6 of the transmitter structure 7, the respectively scanned tracks S1, S2 naturally change. The two sensor elements 5 are preferably each in the form of differential Hall sensors. The two differential Hall sensors can be separate from one another or can be combined to form one module. In the case of a differential Hall sensor, a magnetic field is generated by a permanent magnet. Two Hall elements, which are indicated by dots in FIG. 7 and which follow one another in the rotation direction 8, are located between the magnet. The magnetic flux which passes through said Hall elements depends on whether a tooth or a tooth gap is situated opposite the two Hall elements. A reduction in the magnetic interference signals and an improvement in the signal/noise ratio is achieved by calculating the difference between the two signals of the Hall elements.

The signals which are detected by the first differential Hall sensor in the track S1 and the second differential Hall sensor in the track S2 are illustrated in the middle of FIG. 7. When, for example, the structure transition from the tooth 51 and the tooth gap 52 is detected by the differential Hall sensor in the track S1, the differential Hall sensor generates positive voltage values. In the case of the structure transition from the tooth gap 52 to the tooth 53 which is subsequently detected, a negative voltage value is produced in the differential Hall sensor on account of the difference calculation.

Depending on this detected voltage signal, the differential Hall sensor generates, for example, the sensor signal Se which is illustrated in the bottom part of FIG. 7 and which can comprise a series of, for example square-wave, signal pulses. The first signal pulse 30a is produced when the structure transitions 19 which flank the tooth gap 52 pass through the detection region of the differential Hall sensor, the next signal pulse 30b is produced when the structure transitions which flank the tooth gap 54 pass through said detection region of the differential Hall sensor, and the third signal pulse 30c is produced when the structure transitions which flank the tooth gap 56 pass through said detection region of the differential Hall sensor. The same applies for the second differential Hall sensor which scans the track S2. On account of the orientation of the structure transitions which flank the tooth gap 52, said orientation running parallel in relation to the axis 4, and on account of the orientation of the structure transitions which flank the tooth gap 54, said orientation running in a manner inclined in relation to the axis 4, the two differential Hall sensors in the tracks S1 and S2 generate the first signal pulse 30a at the same time, while the differential Hall sensor in the track

S2 outputs the signal pulse 30b more quickly than the differential Hall sensor in the track S1. The third signal pulse 30c is again generated at the same time. Information about the axial displacement position 6 of the clutch part 3 is contained in the different time interval between the second signal pulse 30b and the first signal pulse 30a in track S1 in relation to track S2, it being possible for said information to be evaluated, for example, using a controller or an electronic circuit part which is associated with the sensor device 25. To this end, the two sensor signals Se of the two differential Hall sensors in the tracks S1 and S2 can be evaluated. If the transmitter structure in FIG. 7 is now displaced along the axial displacement direction 6, the time interval t1 between the signal pulses 30a which are detected in an unchanged manner and the signal pulses 30b which are being displaced changes in a different way for the two differential Hall sensors. The same applies for the time interval t2 between the signal pulses 30b and 30c. In this case, it is advantageously possible to determine the axial displacement position 6 by evaluating the two sensor signals of the differential

Hall sensors as early as immediately after the sensor device 25 is switched on, without said sensor device having to be taught first. The rotation speed is detected in a conventional manner depending on the number of signal pulses detected by a differential Hall sensor in a prespecifiable time interval or depending on the time interval between the signal pulses. This exemplary embodiment can be produced in a particularly expedient manner since the sensor device 25 manages with two inexpensive differential Hall sensors and the transmitter structure can be produced in a simple and inexpensive manner by milling.

A modification to this exemplary embodiment from FIG. 7 provides that only one signal differential Hall sensor is used, for example that differential Hall sensor which scans the track S1 in the top part of FIG. 7 and in the process generates, for example, the top one of the two sensor signals Se in the bottom part of FIG. 7. In the event of an axial displacement of the transmitter structure 7, said differential Hall sensor then scans, for example, the track S2 and generates the lower one of the two sensor signals Se in the bottom part of FIG. 7. Information about the axial displacement path 6 covered is also contained from a change in the time interval t1 in relation to the time interval t2 here. However, in this case, the sensor device 25 cannot identify the axial starting position in which the movable clutch part 3 is located directly after it is switched on. Therefore, in this exemplary embodiment, a learning procedure should first be performed after the sensor device 25 is switched on, it being possible for said learning procedure to be stored, for example, in the software of a controller. In order to teach the sensor device 25, the sensor signal Se is then first evaluated and taught in the event of an axial displacement 6 of the clutch part 3 and of the transmitter structure 7. As soon as it is identified whether and the extent to which the time interval t1 or t2 in FIG. 7 has increased or reduced in the event of an axial displacement of the clutch part to the left or to the right in FIG. 1, the direction and magnitude of the axial displacement can also be correctly identified using only one sensor element 5 in this exemplary embodiment.

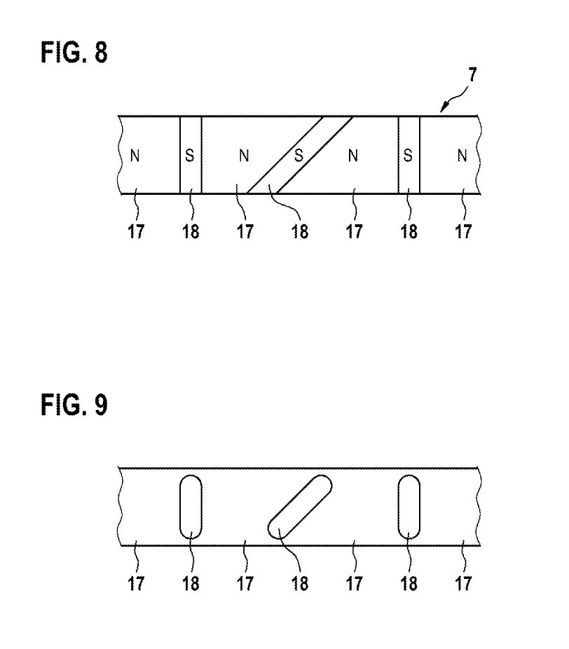

Further exemplary embodiments are possible, in which the structure elements 17, 18 which follow one another in an alternating manner in the rotation direction 8 are formed by corresponding magnetization on the circumference 10 of the rotatable clutch part 3. In this case, structure transitions 19 between the first substructure 14 and the second substructure 15 are preferably formed by magnetic north/south transitions. The sensor element 5 can be in the form of a magnetic field-sensitive sensor element, for example in the form of a Hall element that detects a change in magnetic field in the sensor detection region 9 when a magnetic north/south transition is routed past the sensor element 5. An exemplary embodiment of a magnetic transmitter structure 7 is disclosed in FIG. 8. The structure corresponds to the transmitter structure illustrated in the top part of FIG. 7, the only difference from FIG. 7 here being that magnetic north poles N form the structure elements 17 of the first substructure and magnetic south poles S form the structure elements 18 of the second substructure. One or two differential Hall sensors, for example, can be used in this exemplary embodiment too. Signal evaluation is then performed in a similar manner to the evaluation described with reference to FIG. 7.

FIG. 9 shows a transmitter structure 7 which is similar to the top part of FIG. 7 and which is produced by punching out material from a sheet-metal strip. The sheet-metal strip is then bent around the circumference 10 of the clutch part 3. Evaluation and signal detection can be carried out in a similar manner to the embodiment described with reference to FIG. 7.

However, it is also possible to represent the structure elements 17, 18 of the two substructures, which structure elements follow one another in an alternating manner in the circumferential direction, by a design of the optical surface condition of the circumference 10 of the rotatable part 3. In this case, the transmitter structure 7 is, for example, a flat structure, and the first substructure 14 and the second substructure 15 are formed by an optically different surface of a circumference 10 which is in the form of, for example, a cylinder casing. The sensor element 5 is then in the form of an optical sensor element which detects electromagnetic radiation, in particular light, which is reflected by the surface in the sensor detection region 9. Said radiation can be, for example, a laser. The differently reflective surfaces enable a structure transition 19 from a structure element of the first substructure to a structure element of the second substructure to be detected.

It goes without saying that numerous options for designing the transmitter structure 7 and the sensor device 25 are included within the disclosure content of the invention, it being possible for said options to differ from the exemplary embodiments outlined above without departing from the basic concept of the invention.

1. A clutch sensor system comprising:
a clutch part configured to rotate in a rotation direction about a rotation axis and move axially in a direction of the rotation axis;
a circumferential transmitter structure that is provided on a circumference of the clutch part, and that includes structure elements, the structure elements having:
a first substructure and at least one second substructure that follow each other in an alternating fashion in along the rotation direction; and
structure transitions, the first and second substructures separated from each other by a respective structure transition,
wherein the structure elements are configured such that a circumferential distance between structure transitions depends on an axial displacement position of the clutch part along the direction of the rotation axis; and
a sensor device that includes at least one sensor element configured to detect a rotational movement variable of the rotatable clutch part, such that during rotation of the clutch part, the structure transitions rotate past a sensor detection region of the at least one sensor element, the sensor device further configured to generate a sensor signal in response to detection of the structure transitions rotating past the sensor detection region, the sensor signal including information about the rotational movement variable of the clutch part, and information about the axial displacement position of the clutch part.

2. The clutch sensor system as claimed in claim 1, wherein at least one structure transition has an inclined section which is inclined in relation to the rotation axis of the clutch part, and a structure transition which directly or indirectly follows the at least one structure transition in the rotation direction has a section which does not run parallel in relation to the inclined section.

3. The clutch sensor system as claimed in claim 1, wherein at least one of the first substructure and the second substructure is formed from a series of structure elements of identical design or from a series of structure elements of different design which are arranged in an alternating manner in the rotation direction.

4. The clutch sensor system as claimed in claim 1, wherein the sensor device has a single sensor element or has at least two sensor elements which are arranged at a distance from each other in the direction of the rotation axis.

5. The clutch sensor system as claimed in claim 4, wherein the sensor device has at least one of a differential Hall sensor, a Hall sensor, a Hall IC sensor, an AMR sensor, a GMR sensor, an inductive sensor element, an optical sensor, an ultrasound sensor, and a radar sensor.

6. The clutch sensor system as claimed in claim 1, wherein the sensor signal includes a series of signal pulses depending on the detection of the structure transitions which rotating-past the sensor detection region.

7. The clutch sensor system as claimed in claim 6, wherein:
the sensor signal includes a sequence of at least three successive signal pulses with a first signal pulse, a second signal pulse and a third signal pulse, and
a ratio of a time interval between the first signal pulse and the second signal pulse and of the time interval between the second signal pulse and the third signal pulse includes information about the axial displacement position of the clutch part.

8. The clutch sensor system as claimed in claim 6, wherein a ratio of a pulse duration of a signal pulse of the sensor signal to a period duration of the sensor signal includes information about the axial displacement position of the clutch part.

9. The clutch sensor system as claimed in claim 6, wherein a value representative of the rotational movement variable is detected depending on a number of signal pulses detected in a prespecifiable time interval or depending on a time interval between the signal pulses.

10. The clutch sensor system as claimed in claim 1, wherein:
the structure elements which follow each other in alternating fashion in the rotation direction are defined by a geometric shape of the circumference of the clutch part, the circumference formed with a gearwheel geometry,
the first substructure has teeth as and the second substructure has tooth gaps, which are each situated between two respective teeth, and
the sensor device is configured to detect a change in a magnetic field located in the sensor detection region as teeth and tooth gaps rotate past the sensor detection region of the at least one sensor element of the sensor device.

11. The clutch sensor system as claimed in claim 1, wherein:
the structure elements which follow each other in alternating fashion in the rotation direction are defined by a magnetic pole structure disposed on the circumference of the rotatable clutch part,
the structure transitions are defined between each first and the second substructure by magnetic north/south transitions, and
the sensor device is configured to detect a change in a magnetic field as a magnetic north/south transition rotates past the sensor detection region of the at least one sensor element.

12. The clutch sensor system as claimed in claim 1, wherein:
the structure elements which follow each other in alternating fashion in the rotation direction are defined by a shape of of the circumference of the clutch part configured to have an optical surface condition,
the first substructure and the at least one second substructure have optically different surfaces, and
the at least one sensor element includes an optical sensor element and is configured to detect electromagnetic radiation reflected from the optically different surfaces in the sensor detection region.

13. The clutch sensor system as claimed in claim 1, wherein the clutch sensor system is part of a motor vehicle transmission clutch or part of a separating clutch of the motor vehicle, which separating clutch connects a drive side to an output side.
